(19) United States
(12) Patent Application Publication
(10) Pub. No.: US 2026/0246220 A1
(43) Pub. Date: Aug. 20, 2026

(54) APPARATUS AND METHOD FOR ACOUSTIC CONTROL IN A LASER CHAMBER

(71) Applicant: Cymer, LLC, San Diego, CA (US)

(72) Inventor: Thomas Dickson Steiger, San Diego, CA (US)

(21) Appl. No.: 19/164,366

(22) PCT Filed: Mar. 6, 2024
(86) PCT No.: PCT/IB2024/052176

§ 371 Date: Sep. 11, 2025

Related U.S. Application Data
(60) Provisional application No. 63/455,054, filed on Mar. 28, 2023.

(51) Int. Cl. H01S 3/038

(52) U.S. Cl. CPC H01S 3/038

(57) ABSTRACT

An apparatus for generating laser radiation from discharges in a gap, in a discharge chamber in which the discharges cause acoustic waves that reflect off of internal surfaces in the discharge chamber. The gap is angled with respect to the surfaces of structures in the chamber proximate to the gap so that acoustic waves reflected by those surfaces are less likely to reflect back to their origin and interfere with the operation of the laser especially at high repetition rates.

### CROSS-REFERENCE TO RELATED APPLICATIONS

This application claims priority to U.S. Application No. 63/455,054, filed Mar. 28, 2023, titled LASER CHAMBER HAVING DISCHARGE GAP WITH ACOUSTIC CONTROL, which is incorporated herein in its entirety by reference.

### FIELD

The disclosed subject matter relates to laser discharge chambers in which discharges in a discharge region produce laser radiation and also produce acoustic disturbances which may be undesirably reflected back to the discharge region.

### BACKGROUND

Photolithography is a process by which semiconductor circuitry is patterned on a substrate such as a silicon wafer. A photolithography radiation source provides the deep ultraviolet (DUV) light (wavelengths in a range of about 100 nanometers (nm) to about 400 nm) used to expose a photoresist on the wafer. Often, the radiation source is a laser source and the radiation is a pulsed laser beam. The radiation beam is passed through a beam delivery unit, then a reticle or a mask, and then projected onto a silicon wafer coated with photoresist. In this way, a chip design is patterned onto a photoresist that is then etched and cleaned.

In many systems that produce a laser beam (such as a laser generator) or employ a laser beam (such as a photolithography system), there is an optical train that includes one or more optical components (such as mirrors, gratings, prisms, optical switches, filters, etc.). Optical components in the optical train may, wholly or partially, reflect, process, filter, modify, focus, expand, etc. the laser beam to obtain one or more desired laser beam outputs.

In such systems the laser beam is produced by causing discharges in the discharge (interelectrode) region of one or more laser discharge chambers. One challenge in the design and use of these systems is that the electric discharge used to produce the laser radiation also generates strong acoustic waves inside the discharge region creating gas density modulations that propagate within the laser discharge chamber. Surfaces in the laser discharge chamber may reflect these acoustic waves back into the discharge region and adversely affect the laser's performance. In particular these reflected waves may result in a round trip time-of-flight resonance depending on the inter-pulse delay or discharge repetition rate.

It is in this context that the need for the subject matter of the present disclosure arises.

### SUMMARY

The following presents a succinct summary of one or more embodiments in order to provide a basic understanding of the present invention. This summary is not an extensive overview of all contemplated embodiments and is not intended to identify as key or critical any elements of any embodiments nor delineate the scope of any or all embodiments. Its sole purpose is to present some concepts relating to one or more embodiments in a streamlined form as a prelude to the more detailed description that is presented later.

According to an aspect of an embodiment there is disclosed a discharge chamber comprising a chamber wall extending in a first direction, a first electrode having a first electrode discharge surface, and a second electrode having a second electrode discharge surface, the first electrode discharge surface and the second electrode discharge surface defining a discharge gap, the first and second electrodes being configured to create a plasma discharge in the discharge gap, wherein the first and second electrode discharge surfaces extend parallel to each other in a second direction at an angle to the first direction, and wherein the first electrode has a top surface parallel to the chamber wall, the first electrode thus having a wedge-shaped cross section between the first electrode discharge surface and the top surface.

The first electrode may be a cathode and the top surface may be mounted to the chamber wall. The discharge chamber may further comprise an electrode support mechanically coupled to the second electrode and arranged to support the second electrode within the discharge chamber, with a magnitude of the angle being selected to prevent acoustic waves originating from an origin region in the discharge gap during a discharge in the discharge gap from being reflected back to the origin region during a next discharge by the electrode support. The magnitude of the angle may be in a range of 0.5 degrees to 10 degrees.

The discharge chamber may further comprise an electrode support mechanically coupled to the second electrode and arranged to support the second electrode within the discharge chamber, at least a portion of the electrode support being disposed within a distance D of the discharge gap. The distance D may be less than two inches.

The discharge chamber may further comprise a preionizer extending parallel to the chamber wall and disposed laterally adjacent the first electrode, at least a portion of the preionizer being disposed within a distance D of the discharge gap. The distance D may be less than two inches.

The magnitude of the angle may be selected to prevent acoustic waves originating from an origin region in the discharge gap during a discharge in the discharge gap from being reflected back to the origin region during a next discharge by the preionizer. The magnitude of the angle may be in a range of 0.5 degrees to 10 degrees.

The discharge chamber may further comprise an insulator disposed parallel to the chamber wall and disposed laterally adjacent the first electrode proximate to the discharge gap. The magnitude of the angle may be selected to prevent acoustic waves originating from an origin region in the discharge gap during a discharge in the discharge gap from being reflected back to the origin region during a next discharge by the insulator. The magnitude of the angle may be in a range of 0.5 degrees to 10 degrees.

According to another aspect of an embodiment there is disclosed an apparatus comprising a laser chamber extending along an optical axis of the chamber in a first direction, a first elongated electrode disposed in the laser chamber and having a first electrode discharge surface, a second elongated electrode disposed in the laser chamber and having a second electrode discharge surface, the first electrode discharge surface and the second electrode discharge surface being spaced apart from each other and extending parallel to one another in a second direction at an angle to the first direction and defining a discharge gap extending in the second direction. At least one acoustic reflecting surface is arranged proximate to the discharge gap and extending adjacent to one of the first electrode and the second electrode in the first direction, wherein a magnitude of the angle is selected to prevent acoustic waves originating from an origin region in the discharge gap during a discharge in the discharge gap from being reflected back to the origin region during a next discharge by the at least one acoustic reflecting surface.

The at least one acoustic reflecting surface may comprise a surface of a preionizer extending in the first direction and disposed laterally adjacent the first elongated electrode, at least a portion of the preionizer being further disposed within a distance D of the discharge gap. The distance D may be less than two inches.

The at least one acoustic reflecting surface may comprise an insulator extending in the first direction and proximate to the discharge gap.

The at least one acoustic reflecting surface may comprise a surface of an electrode support arranged to mechanically support the second electrode and extending in the first direction proximate to the discharge gap.

The magnitude of the angle may be in a range of 0.5 degrees to 10 degrees.

Further embodiments, features, and advantages of the subject matter of the present disclosure, as well as the structure and operation of the various embodiments, are described in detail below with reference to the accompanying drawings.

### BRIEF DESCRIPTION OF THE DRAWINGS

The accompanying drawings, which are incorporated herein and form part of the specification, illustrate the present invention and, together with the description, further serve to explain the principles of the presently disclosed subject matter and to enable a person skilled in the relevant art(s) to make and use the presently disclosed subject matter.

FIG. 1 is a schematic diagram, not to scale, of an overall broad conception of a photolithography system.

FIG. 2 is a schematic diagram, not to scale, of an overall broad conception of an illumination system such as might be used in the photolithography system of FIG. 1.

FIG. 3 is a cross section, not to scale, of a discharge chamber such as might be used in in the illumination system of FIG. 2.

FIG. 4 is a cross section, not to scale, of a portion of the discharge chamber of FIG. 3.

FIG. 5 is a perspective view, not to scale, of an arrangement of components in the discharge chamber of FIG. 3.

FIG. 6 is a diagram, not to scale, of an arrangement of electrodes in a discharge chamber according to an aspect of an embodiment.

FIG. 7 is a diagram, not to scale, of an arrangement and configuration of electrodes in a discharge chamber according to an aspect of an embodiment.

FIG. 8 is a diagram, not to scale, of an arrangement of components in a discharge chamber according to an aspect of an embodiment.

Further features and advantages of the invention, as well as the structure and operation of various embodiments of the invention, are described in detail below with reference to the accompanying drawings. It is noted that the scope of the presently disclosed subject matter is not limited to the specific embodiments described herein. Such embodiments are presented herein for illustrative purposes only. Additional embodiments will be apparent to persons skilled in the relevant art based on the teachings presented herein.

### DETAILED DESCRIPTION

Various embodiments are now described with reference to the drawings, wherein like reference numerals are used to refer to like elements throughout. In the following description, for purposes of explanation, numerous specific details are set forth in order to promote a thorough understanding of one or more embodiments. It may be evident in some or all instances, however, that any embodiment described below can be practiced without adopting the specific design details associated with it below. In other instances, well-known structures and devices are shown in block diagram form in order to facilitate description of one or more embodiments. This summary is not an extensive overview of all contemplated embodiments and is not intended to single out as key or critical any elements of any embodiments nor delineate the scope of any or all embodiments.

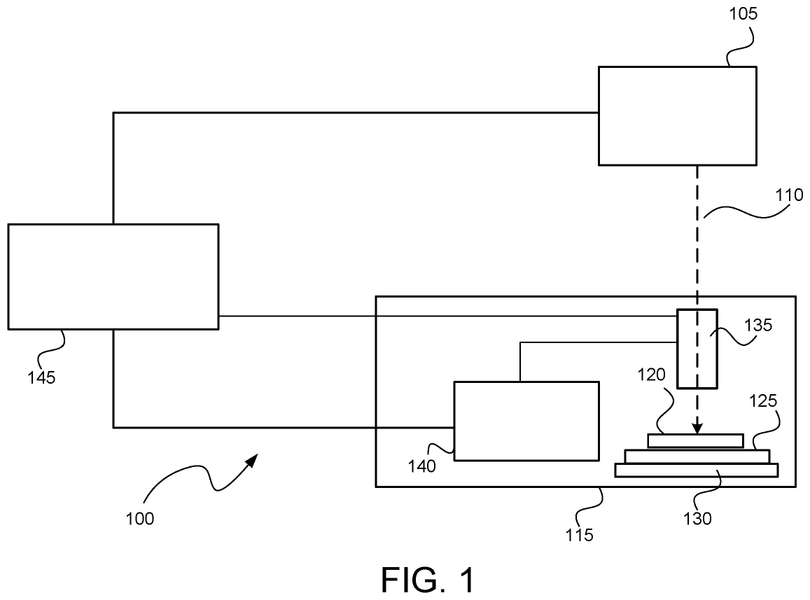

Systems such as those described herein may render benefits in a wide range of applications and implementations. For the sake of having a specific nonlimiting example to facilitate description, one such application is in semiconductor photolithography. FIG. 1 shows a photolithography system 100 that includes an illumination system 105. As described more fully below, the illumination system 105 includes a light source that produces a pulsed light beam 110 and directs it to a photolithography exposure apparatus 115 such as may be a scanner, that patterns microelectronic features on a wafer 120. The wafer 120 is placed on a wafer table 125 constructed to hold wafer 120 and connected to a positioner 130 configured to accurately position the wafer 120 in accordance with certain parameters.

The pulsed light beam 110 may have a wavelength in the DUV range, for example, with a wavelength of 248 nanometers (nm) or 193 nm. The scanner 115 includes an optical arrangement 135 having, for example, one or more condenser lenses, a mask, and an objective arrangement. The mask is movable along one or more directions, such as along an optical axis of the pulsed light beam 110 or in a plane that is perpendicular to the optical axis. The objective arrangement includes a projection lens and enables an image transfer to occur from the mask to photoresist on the wafer 120. The illumination system 105 adjusts the range of angles for the pulsed light beam 110 impinging on the mask. The illumination system 105 also homogenizes (makes uniform) the intensity distribution of the pulsed light beam 110 across the mask.

The scanner 115 can include, among other features, a lithography controller 140 that controls how layers are printed on the wafer 120. The lithography controller 140 may include a memory that stores information such as process recipes that determine the parameters of the beam including a length of the exposure on the wafer 120 based on, for example, the mask used, as well as other factors that affect exposure. During lithography, a burst of pulses of the pulsed light beam 110 illuminates the same area of the wafer 120 to constitute an illumination dose.

The photolithography system 100 also preferably includes a control system 145. In general, the control system 145 includes one or more of digital electronic circuitry, computer hardware, firmware, and software. The control system 145 can be centralized or be partially or wholly distributed throughout the photolithography system 100.

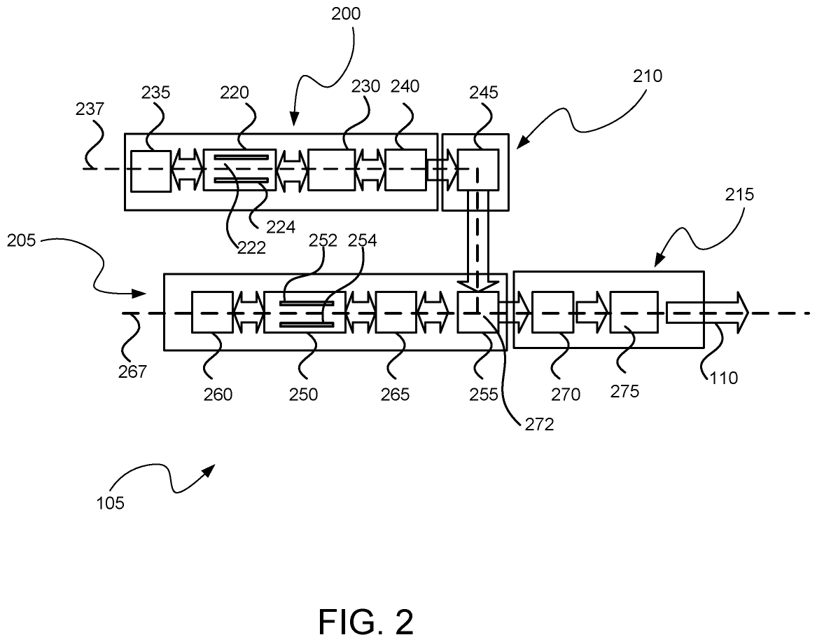

FIG. 2 shows a pulsed laser source that produces a pulsed laser beam as the light beam 110 as an example of an illumination system 105. FIG. 2 shows a two-chamber laser system as a nonlimiting example but it will be understood that the principles explained herein are equally applicable to a single chamber laser system or a laser system having more than two chambers. The gas discharge laser system may include, e.g., a solid state or gas discharge master oscillator (“MO”) seed laser system 200, an amplification stage, e.g., a power ring amplifier (“PRA”) stage 205, relay optics 210, and laser system output subsystem 215. The seed system 200 may include, e.g., an MO chamber 220 which includes a pair of electrodes 222 and 224.

The MO seed laser system 200 may also include a master oscillator output coupler (“MO OC”) 230, which may comprise a partially reflective mirror, forming an MO discharge chamber 220 with an oscillator cavity defined by a reflective grating (not shown) in a line narrowing module (“LNM”) 235 that oscillates to form the seed laser output pulse. The MO seed laser system 200 may also include a line-center analysis module (“LAM”) 240. A MO wavefront engineering box (“WEB”) 245 may serve to redirect the output of the MO seed laser system 200 toward the amplification stage 205, and may include, e.g., a multi prism beam expander (not shown) and an optical delay path (not shown). The beam path through the LNM 235, the MO discharge chamber 220, the MO OC 230, and the LAM 240 defines an optical axis 237 for each of these components.

The amplification stage 205 may include, e.g., a PRA discharge chamber 250, which also may be an oscillator, e.g., formed by seed beam injection and output coupling optics (not shown) that may be incorporated into a PRA WEB 255. The beam may be redirected back through the gain medium in the PRA discharge chamber 250 by a beam reverser (“BR”) 260. The PRA WEB 255 may incorporate a partially reflective input/output coupler (not shown) and a maximally reflective mirror for the nominal operating wavelength (e.g., at around 193 nm for an ArF system) and one or more prisms. The PRA discharge chamber 250 may also include a pair of electrodes 252 and 254.

A bandwidth analysis module (“BAM”) 265 may receive the output laser light beam of pulses from PRA discharge chamber 250 and pick off a portion of the light beam for metrology purposes, e.g., to measure the output bandwidth and pulse energy. The laser output light beam of pulses then passes through the PRA WEB 255 to an optical pulse stretcher (“OPuS”) 270 and an autoshutter, in this case a combined autoshutter metrology module (“CASMM”) 275, which may also be the location of a pulse energy meter. One purpose of the OPUS 270 may be, e.g., to convert a single output laser pulse into a pulse train. Secondary pulses created from the original single output pulse may be delayed with respect to each other. By distributing the original laser pulse energy into a train of secondary pulses, the effective pulse length of the laser can be expanded and at the same time the peak pulse intensity reduced. The OPUS 270 may accordingly be arranged to receive the laser beam from the PRA WEB 255 and direct its output to the CASMM 275.

The beam path through the BR 260, the PA discharge chamber 250, and the BAM 265 defines an optical axis 267 for each of these components.

The PRA discharge chamber 250 and the MO discharge chamber 220 are configured as chambers in which electrical discharges between the electrodes cause lasing gas discharges in a lasing gas to create an inverted population of high energy molecules or excimers, including, e.g., ArF, KrF, F₂, XeF, and/or XeCl, to produce relatively broad band radiation that may be line narrowed to a relatively very narrow bandwidth and center wavelength selected in the LNM 235.

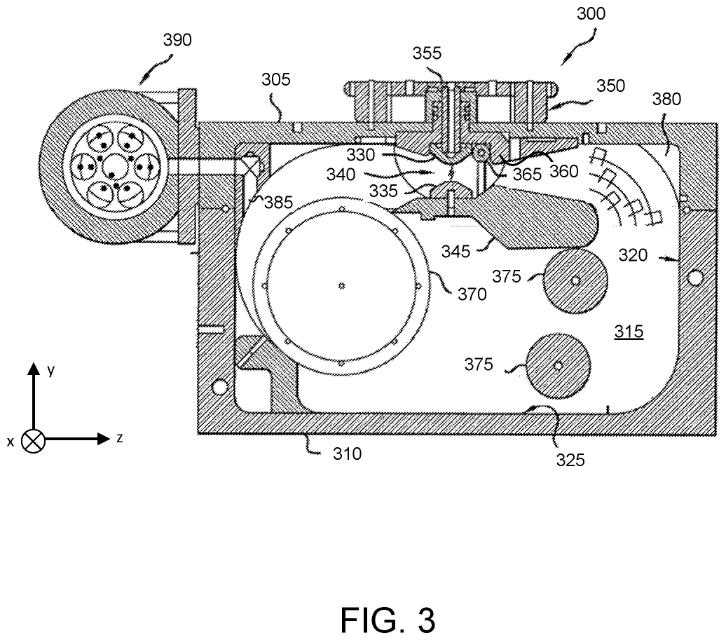

Turning now to FIG. 3 there is shown a laser discharge chamber 300 which may serve, for example, as the PRA discharge chamber 250 or the MO discharge chamber 220. The chamber 300 may be composed, e.g., of an upper chamber body 305 and a lower chamber body 310, which may, when connected to each other by suitable means, e.g., by bolting, serve to define a chamber interior 315. The upper chamber body 305 and lower chamber body 310 also define a chamber interior vertical wall 320 with the lower chamber body 310 defining a chamber interior horizontal bottom wall 325.

In this specification including the claims the terms “up,” “down,” “upper,” “lower,” “top,” “bottom,” “vertical,” “horizontal,” and like terms are intended to connote relative orientation only and not any absolute orientation such as orientation with respect to gravity unless otherwise indicated or clear from context.

Also contained within the chamber interior 315 is, e.g., a gas discharge system comprising two elongated opposing electrodes, a cathode 330 and an anode 335, defining between them an elongated gas discharge gap or region 340, wherein, in response to a sufficient voltage being imposed across the cathode 330 and anode 335, a discharge occurs in the gas discharge region 340 resulting in the production of radiation at or near a characteristic center wavelength, that is optically directed along the optical axis of the output laser light pulse generally aligned to the longitudinal optical axis of the laser discharge chamber 300 along the X axis (out of the plane of the figure) as indicated by the inset.

Also within the chamber interior 315 may be, e.g., an anode support bar 345. The anode 335 may be electrically connected to the upper chamber body 305 through a plurality of current returns, with the upper chamber body 305, along with lower chamber body 310, being kept at a common voltage, e.g., at ground voltage.

The cathode 330 may, e.g., be connected to an electrical discharge high voltage feed through an assembly 350, e.g., by a high voltage feed through 355, which passes through a main insulator 360. The main insulator 360 may keep the cathode 330 electrically isolated from the upper chamber body 305. Also within the chamber interior 315 may be, e.g., a preionizer 365, which may be, for example, a preionization tube, adjacent the cathode 330. The preionizer 365 may be configured as an elongate hollow, dielectric (e.g., ceramic) tube surrounding an electrode. More information about preionizers may be found in U.S. Pat. No. 7,542,502, titled “Thermal-expansion Tolerant, Preionizer Electrode for a Gas Discharge Laser,”, issued Jun. 2, 2009.

All patent applications, patents, and printed publications cited herein are incorporated herein by reference in their entireties, except for any definitions, subject matter disclaimers, or disavowals, and except to the extent that the incorporated material is inconsistent with the express disclosure herein, in which case the language in this disclosure controls.

Also within the chamber interior 315 may be a gas circulation system comprising a gas circulation fan 370, which may be, e.g., a generally cylindrical crossflow fan 370. The fan 370 serves to move gas within the chamber interior 315, generally in a circular fashion as seen in the cross-sectional view of FIG. 3, in order to remove gas that contains ionized particles and debris and is depleted of F2 from the discharge region 340 between successive gas discharges, and thus to replenish the discharge region 340 with fresh gas before the next gas discharge. The gas circulation system may also include a plurality of heat exchangers 375 in the generally circular gas flow path to remove heat added to the gas, e.g., by the discharges and the operation of the fan 370.

The gas circulation system may also have a plurality of curved baffles 380 and a flow directing vane 385, which may serve to shape the generally circular gas flow path out of the discharge region 340 toward the heat exchangers 375 and ultimately the intake of the fan 370, and from the output of the fan 370 to the discharge region 340, respectively. The upper chamber body 305 may also have an attached metal fluoride trap 390 in fluid communication with the chamber interior 315.

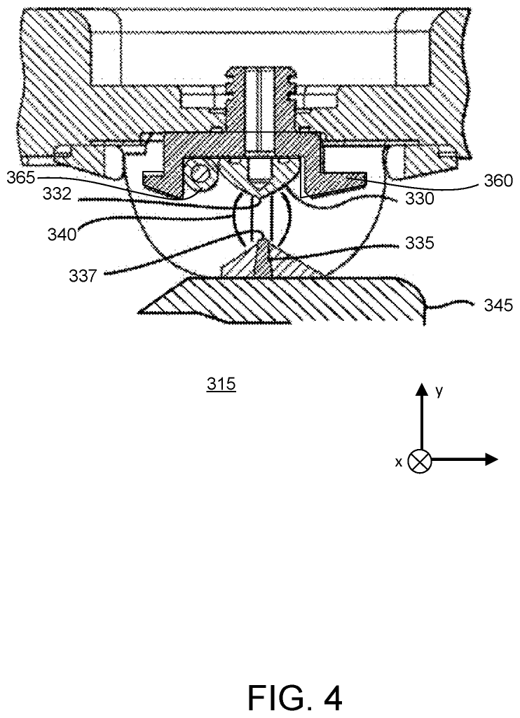

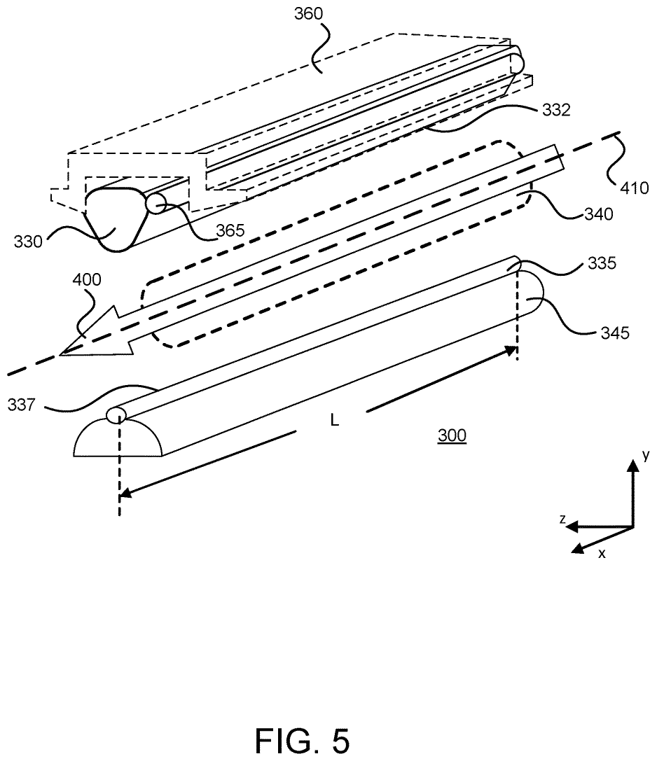

FIG. 4 is a schematic view that further illustrates how the electrodes and adjacent components are situated in the gas discharge laser chamber. As shown in FIG. 4, anode 335 and cathode 330 are disposed in an opposing relationship so that elongated cathode discharge surface 332 faces elongated discharge anode surface 337. Anode 335 is mounted on an anode support bar 345. Gas discharge region 340, which is the space defined between elongated cathode discharge surface 332 and elongated anode discharge surface 337, typically has a height (direction of the Y axis) of about 0.5 inch. In one example, the length L (see FIG. 5) of each of the anode 335 and the cathode 330 may for example lie within the range of about 20 inches to 30 inches. As noted above, the width of the discharge area and the length of the electrodes may be varied to suit the needs of particular applications. Also visible in FIG. 4 is preionizer 365.

FIG. 5 is a perspective view of an example of the arrangement of components in the laser discharge chamber 300. As can be seen in FIG. 5, the elongate cathode discharge surface 332 of the cathode 330 faces an elongate anode discharge surface 337 of the anode 335 across a gap defining the discharge region 340. When a discharge occurs in the discharge region 340, radiation generated by the discharge propagates in the direction indicated by arrow 400. Also shown is an optical axis 410 for the laser discharge chamber 300. As depicted, the optical axis 410 may be regarded as extending parallel to an X axis of a right-handed cartesian coordinate system. The elongate cathode 330, the elongate anode 335, and the gap defining the discharge region 340 all extend parallel to the optical axis 410. Also visible in FIG. 5 is preionizer 365 which also extends parallel to the optical axis 410. FIG. 5 also shows in phantom the main insulator 360 which also extends parallel to the optical axis 410. Also visible in FIG. 5 is the anode support bar 345 which also extends parallel to the optical axis 410.

As mentioned, the discharge occurring in the discharge region 340 generates acoustic waves inside the discharge chamber 300. The acoustic waves generated by the discharge propagate outward from the discharge region 340, reflect off of internal surfaces of the laser discharge chamber 300, and then return to the discharge region where they distort the laser beam produced by subsequent pulses.

The amount of distortion in general depends on the relationship between the repetition rate of the pulses and the time-of-flight distance of acoustic waves travelling at the speed of sound from the discharge area to reflecting surfaces within the laser discharge chamber and back again. At higher repetition rates, for example, in the range of 5.8 kHz to 6 kHz, the reflecting surfaces more proximate to the discharge area 340 dominate the resonant acoustic distortion effect. These include surfaces above and below the discharge region such as surfaces of the preionizer, the main insulator, and the anode support bar facing the discharge region.

To address this higher repetition rate distortion, according to an aspect of an embodiment the cathode discharge surface and the anode discharge surface are both oriented so as to be longitudinally parallel to each other but tilted with respect to an optical axis of the laser discharge chamber defined by the optical elements at the respective ends of the discharge chamber establishing the resonant laser cavity. Hence, the erosion rate can be constant along the length of the electrodes but the discharge surfaces are no longer parallel to structures proximate to the discharge region that can cause reflections (e.g. the main insulator, the preionizer, and the anode support bar). The cathode discharge surface tilt may be physically machined into the cathode such that the cathode is taller (more extensive in the y dimension) at one end than the other.

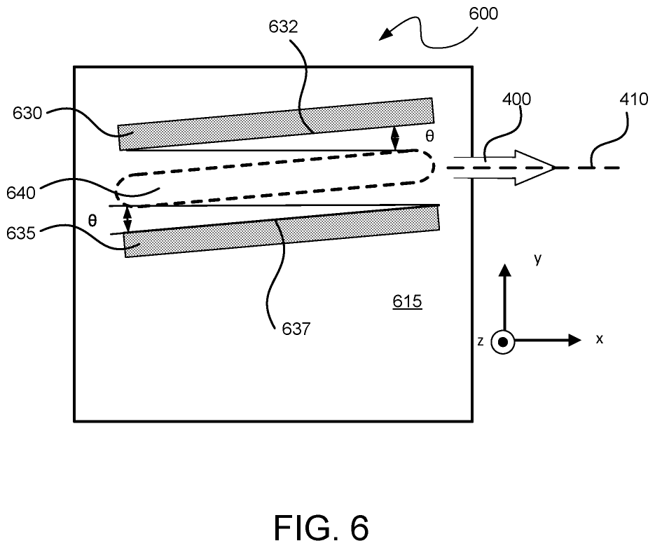

An arrangement incorporating these features is shown in FIG. 6. In FIG. 6, a laser discharge chamber 600 is provided with a first electrode 630 and a second electrode 635. The first electrode 630 may be arranged to serve as a cathode. The second electrode 635 may be arranged to function as an anode. As can be seen, the discharge surface 632 of the first electrode 630 is arranged at a angle θ (rotation around the Z axis, also referred to herein as a vertical angle because it is with respect to the horizontal XZ plane) with respect to a line parallel to the optical axis 410 of the discharge chamber 600. The discharge surface 637 of the second electrode 635 is also arranged at an angle θ with respect to a line parallel to the optical axis 410 of the discharge chamber 600. Thus the discharge surface 632 of the first electrode 630 and the discharge surface 637 of the second electrode 635 are parallel to one another. The discharge region 640 between the discharge surface 632 of the first electrode 630 and the discharge surface 637 of the second electrode 635 is at the same angle θ with respect to a line parallel to the optical axis 410.

In other words, the orientation of the discharge region 640 is in effect rotated counterclockwise or clockwise by an angle θ with respect to an orientation that is parallel to the optical axis 410. This means that the discharge region 640 is at the same angle θ with respect to acoustic wave-reflecting surfaces proximate to the discharge region 640 that are arranged parallel to the optical axis 410 such as the main insulator, preionizer, and anode support bar. Thus, acoustic waves originating from a discharge in the discharge region 640 encountering these surfaces will tend to be reflected in a direction other than directly back towards the subregion of the discharge region 640 at which they originated to a return subregion sufficiently displaced from the origin subregion that they are less likely to produce a time-of-flight resonance that interferes with the next discharge in the discharge region 640. Here and elsewhere in this specification including the claims the term “proximate to” means within two inches of the discharge region 640. It is in general surfaces within this range of the discharge region 640 that contribute most significantly to time-of-flight resonances at higher repetition rates.

The magnitude of the angle θ may be chosen so as to be small enough not to introduce any significant deviation or obstruction in the optical path through the laser discharge chamber 600 but large enough so that acoustic waves reflected from proximate surfaces are not reflected directly back to the portion of the discharge region from which they originated in time to interfere with the next discharge. In general, the angle θ will be in a range from about 0.5° to about 10°.

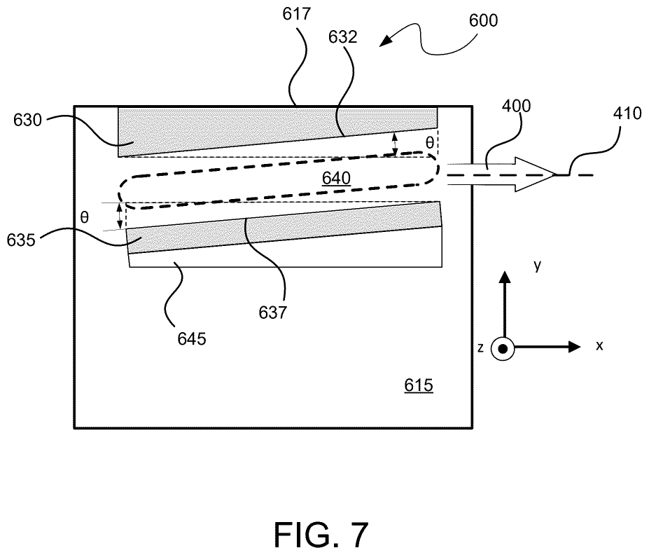

FIG. 7 shows an arrangement in which the first electrode 630 (e.g., the cathode) is attached directly to the upper chamber wall 617 of the laser discharge chamber 600. Thus, the first electrode has a generally wedge-shaped cross section in the XY plane, that is, between the upper chamber wall 617 and the first electrode discharge surface 632, with the bottom slanted surface of the wedge forming, the first electrode discharge surface 632, forming an angle θ with a line parallel to the optical axis 410.

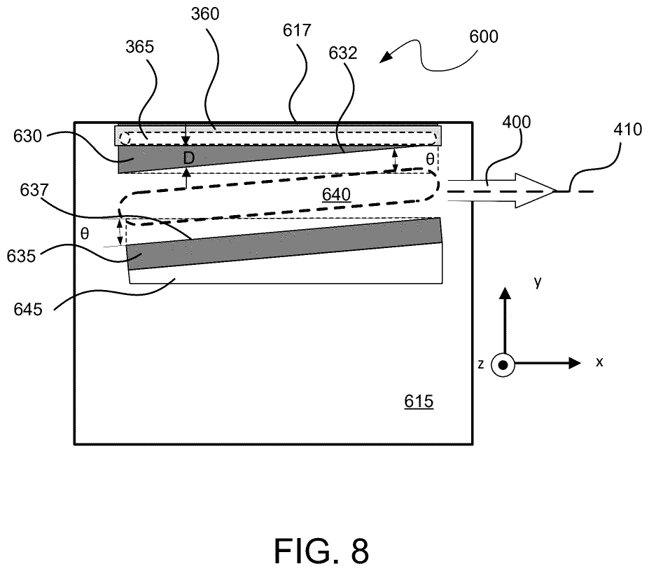

FIG. 8 also shows an arrangement in which the first electrode 630 is attached directly to the upper wall 617 of the laser discharge chamber 600 and so which has a generally wedge-shaped cross section in the XY plane. FIG. 8 also shows some components having acoustic reflecting surfaces proximate to the discharge region 640 which would otherwise reflect acoustic waves back to their source region in the discharge region 640 between the first electrode discharge surface 632 and the second electrode discharge surface 637. These elements include the main insulator 360 (light gray shading), the preionizer 365 (in phantom because it is covered by the main insulator 360), and the second electrode (anode) support bar 645. Also shown in FIG. 8 is the distance D between at least a portion of the preionizer 365 and the interelectrode discharge gap 640. It will be appreciated that this distance D will vary along the length of the first electrode 630 but, in general, in some embodiments the distance D will be less than two inches along the entire length of the preionizer 365. In fact, the vertical (Y axis) distance between the discharge gap and the preionizer 365 will vary as a function of the lengthwise (along the X axis) region of the measurement. In the example shown, this function is linear and decreases with increasing distance along the X axis. At least portions of the second electrode support bar 645 will in general also be within the distance D of the interelectrode discharge gap 640.

Some of the above description is in terms of functional block diagrams with some functions allocated to some blocks and other functions allocated to other blocks. It will be understood that the division between blocks and the allocations are arbitrary and that different divisions and allocations are possible so long as the overall functions are carried out as described above.

The above description includes examples of multiple embodiments. It is, of course, not possible to describe every conceivable combination of components or methodologies for purposes of describing these embodiments, but one of ordinary skill in the art may recognize that many further combinations and permutations of elements of the various embodiments are possible based on the disclosure. Accordingly, the described embodiments are intended to be representative of and disclose all such alterations, modifications, and variations that fall within the spirit and scope of the appended claims.

Furthermore, to the extent that the term “includes” is used in either the detailed description or the claims, such term is intended to be inclusive in a manner similar to the term “comprising” as “comprising” is construed when employed as a transitional word in a claim. Also, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

Aspects and implementations of the present disclosure can be further described using the following clauses:

1. A discharge chamber comprising:
a chamber wall extending in a first direction;
a first electrode having a first electrode discharge surface; and
a second electrode having a second electrode discharge surface, the first electrode discharge surface and the second electrode discharge surface defining a discharge gap, the first and second electrodes being configured to create a plasma discharge in the discharge gap,
wherein the first and second electrode discharge surfaces extend parallel to each other in a second direction at an angle to the first direction, and
wherein the first electrode has a top surface parallel to the chamber wall, the first electrode thus having a wedge-shaped cross section between the first electrode discharge surface and the top surface.

2. The discharge chamber as in clause 1, wherein the first electrode is a cathode and the top surface is mounted to the chamber wall.

3. The discharge chamber of clause 1 further comprising an electrode support mechanically coupled to the second electrode and arranged to support the second electrode within the discharge chamber, wherein a magnitude of the angle is selected to prevent acoustic waves originating from an origin region in the discharge gap during a discharge in the discharge gap from being reflected back to the origin region during a next discharge by the electrode support.

4. The discharge chamber of clause 3 wherein the magnitude of the angle is in a range of 0.5 degrees to 10 degrees.

5. The discharge chamber of clause 1 further comprising an electrode support mechanically coupled to the second electrode and arranged to support the second electrode within the discharge chamber, at least a portion of the electrode support being disposed within a distance D of the discharge gap.

6. The discharge chamber of clause 5 wherein the distance D is less than two inches.

7. The discharge chamber of clause 1 further comprising a preionizer extending parallel to the chamber wall and disposed laterally adjacent to the first electrode, at least a portion of the preionizer being disposed within a distance D of the discharge gap.

8. The discharge chamber of clause 7 wherein the distance D is less than two inches.

9. The discharge chamber of clause 7 wherein a magnitude of the angle is selected to prevent acoustic waves originating from an origin region in the discharge gap during a discharge in the discharge gap from being reflected back to the origin region during a next discharge by the preionizer.

10. The discharge chamber of clause 9 wherein the magnitude of the angle is in a range of 0.5 degrees to 10 degrees.

11. The discharge chamber of clause 1 further comprising an insulator disposed parallel to the chamber wall and disposed laterally adjacent the first electrode proximate to the discharge gap.

12. The discharge chamber of clause 11 wherein a magnitude of the angle is selected to prevent acoustic waves originating from an origin region in the discharge gap during a discharge in the discharge gap from being reflected back to the origin region during a next discharge by the insulator.

13. The discharge chamber of clause 12 wherein the magnitude of the angle is in a range of 0.5 degrees to 10 degrees.

14. An apparatus comprising:
a laser chamber extending along an optical axis of the chamber in a first direction;
a first elongated electrode disposed in the laser chamber and having a first electrode discharge surface;
a second elongated electrode disposed in the laser chamber and having a second electrode discharge surface, the first electrode discharge surface and the second electrode discharge surface being spaced apart from each other and extending parallel to one another in a second direction at an angle to the first direction and defining a discharge gap extending in the second direction; and
at least one acoustic reflecting surface arranged proximate to the discharge gap and extending adjacent to one of the first electrode and the second electrode in the first direction,
wherein a magnitude of the angle is selected to prevent acoustic waves originating from an origin region in the discharge gap during a discharge in the discharge gap from being reflected back to the origin region during a next discharge by the at least one acoustic reflecting surface.

15. The apparatus of clause 14 wherein the at least one acoustic reflecting surface comprises a surface of a preionizer extending in the first direction and disposed laterally adjacent the first elongated electrode, at least a portion of the preionizer being further disposed within a distance D of the discharge gap.

16. The apparatus of clause 15 wherein the distance D is less than two inches.

17. The apparatus of clause 14 wherein the at least one acoustic reflecting surface comprises an insulator extending in the first direction and proximate to the discharge gap.

18. The apparatus of clause 14 wherein the at least one acoustic reflecting surface comprises a surface of an electrode support arranged to mechanically support the second electrode and extending in the first direction proximate to the discharge gap.

19. The apparatus of clause 14 wherein the magnitude of the angle is in a range of 0.5 degrees to 10 degrees.

The above-described aspects and implementations and other implementations are within the scope of the following claims.

1. A discharge chamber comprising:
a chamber wall extending in a first direction;
a first electrode having a first electrode discharge surface; and
a second electrode having a second electrode discharge surface, the first electrode discharge surface and the second electrode discharge surface defining a discharge gap,
wherein the first and second electrode discharge surfaces extend parallel to each other in a second direction at an angle to the first direction, and
wherein the first electrode has a top surface parallel to the chamber wall, the first electrode thus having a wedge-shaped cross section between the first electrode discharge surface and the top surface.

2. The discharge chamber as in claim 20, wherein the first electrode is a cathode and the top surface is mounted to the chamber wall.

3. The discharge chamber of claim 1 further comprising an electrode support mechanically coupled to the second electrode and arranged to support the second electrode within the discharge chamber.

4. The discharge chamber of claim 1 wherein a magnitude of the angle is in a range of 0.5 degrees to 10 degrees.

5. The discharge chamber of claim 1 further comprising an electrode support mechanically coupled to the second electrode and arranged to support the second electrode within the discharge chamber, at least a portion of the electrode support being disposed within a distance D of the discharge gap.

6. The discharge chamber of claim 5 wherein the distance D is less than two inches.

7. The discharge chamber of claim 1 further comprising a preionizer extending parallel to the chamber wall and disposed laterally adjacent to the first electrode, at least a portion of the preionizer being disposed within a distance D of the discharge gap.

8. The discharge chamber of claim 7 wherein the distance D is less than two inches.

9. The discharge chamber of claim 7 wherein a magnitude of the angle is selected to prevent acoustic waves originating from an origin region in the discharge gap during a discharge in the discharge gap from being reflected back to the origin region during a next discharge by the preionizer.

10. The discharge chamber of claim 9 wherein a magnitude of a second angle between the preionizer and the first electrode is in a range of 0.5 degrees to 10 degrees.

11. The discharge chamber of claim 1 further comprising an insulator disposed parallel to the chamber wall and disposed laterally adjacent the first electrode proximate to the discharge gap.

12. The discharge chamber of claim 11 wherein a magnitude of the angle is selected to prevent acoustic waves originating from an origin region in the discharge gap during a discharge in the discharge gap from being reflected back to the origin region during a next discharge by the insulator.

13. The discharge chamber of claim 12 wherein a magnitude of a third angle between the insulator and the first electrode is in a range of 0.5 degrees to 10 degrees.

14. An apparatus comprising:
a laser chamber extending along an optical axis of the chamber in a first direction;
a first elongated electrode disposed in the laser chamber and having a first electrode discharge surface;
a second elongated electrode disposed in the laser chamber and having a second electrode discharge surface, the first electrode discharge surface and the second electrode discharge surface being spaced apart from each other and extending parallel to one another in a second direction at an angle to the first direction and defining a discharge gap extending in the second direction; and
at least one acoustic reflecting surface arranged proximate to the discharge gap and extending adjacent to one of the first electrode and the second electrode in the first direction.

15. The apparatus of claim 14 wherein the at least one acoustic reflecting surface comprises a surface of a preionizer extending in the first direction and disposed laterally adjacent the first elongated electrode, at least a portion of the preionizer being further disposed within a distance D of the discharge gap.

16. The apparatus of claim 15 wherein the distance D is less than two inches along an entire length of the preionizer.

17. The apparatus of claim 14 wherein the at least one acoustic reflecting surface comprises an insulator extending in the first direction and proximate to the discharge gap.

18. The apparatus of claim 14 wherein the at least one acoustic reflecting surface comprises a surface of an electrode support arranged to mechanically support the second electrode and extending in the first direction proximate to the discharge gap.

19. (canceled)

20. The discharge chamber as in claim 1, wherein the first electrode has a top surface parallel to the chamber wall, and the first electrode has a wedge-shaped cross section between the first electrode discharge surface and the top surface.

21. The apparatus of claim 14 wherein the discharge gap is oriented upward along with a propagation direction of a radiation.
